(19) United States
(12) Patent Application Publication
(10) Pub. No.: US 2009/0185108 A1
(43) Pub. Date: Jul. 23, 2009

(54) POLARIZER AND DISPLAY DEVICE HAVING THE SAME

(75) Inventors: Won-Sang PARK, Yongin-si (KR); Yi LI, Yongin-si (KR)

Correspondence Address: CANTOR COLBURN, LLP, 20 Church Street, 22nd Floor, Hartford, CT, 06103, US

(73) Assignee: Samsung Electronics Co., Ltd., Suwon-si (KR)

(21) Appl. No.: 12/277,767

(22) Filed: Nov. 25, 2008

(30) Foreign Application Priority Data
Jan. 21, 2008 (KR) 10-2008-0006278

(51) Int. Cl. G02F 1/13357; G02B 5/30; F21V 9/14

(52) U.S. Cl. 349/65; 359/485; 362/19

(57) ABSTRACT

A polarizer and a display device having the polarizer. The polarizer includes a polarization layer, a support layer formed on at least one side of the polarization layer, and a diffusion adhesive layer formed on the polarization layer which diffuses light incident from the polarization layer and prevents a diffused reflection of light incident from an opposite direction of the polarization layer.

This application claims priority to Korean Patent Application No. 10-2008-0006278 filed on Jan. 21, 2008, and all the benefits accruing therefrom under 35 U.S.C. §119, the contents of which in its entirety are herein incorporated by reference.

### BACKGROUND OF THE INVENTION

1. Field of the Invention

The present invention relates to a display device. More particularly the present invention relates to a polarizer which improves a light view angle and a display device including the same.

2. Description of the Related Art

Liquid crystal display (“LCD”) devices represent images by adjusting light transmittance with the liquid crystal layer applied with electric fields, which is disposed between two substrates. The use of LCD devices gradually increases owing to their merits, such as compact, slim design, and reduced power consumption.

Twisted nematic (“TN”) mode LCD devices draw more attention because of their excellent optical and response properties. A TN mode LCD device includes an upper substrate, a lower substrate, an alignment layer, and a liquid crystal layer. In a conventional TN mode LCD device, liquid crystal molecules are aligned in a spiral manner due to the alignment layer between the upper and lower substrates. As a consequence, the display quality of the conventional TN mode LCD device including contrast ratio and color tone may vary with the view angle. In particular, the conventional TN mode LCD devices may cause a color shift phenomenon that makes the same color seen differently depending on the view angle.

### BRIEF SUMMARY OF THE INVENTION

The present invention has made an effort to solve the above-stated problems and aspects of the present invention provide a polarizer for improving the view angle and a display device which improves the light view angle.

In an exemplary embodiment, the present invention provides a polarizer including a polarization layer, a support layer formed on at least one side of the polarization layer, and a diffusion adhesive layer formed on the polarization layer which diffuses light incident from the polarization layer and prevents a diffused reflection of light incident from an opposite direction of the polarization layer.

According to an exemplary embodiment, the diffusion adhesive layer includes transparent diffusion particles including at least one of silica beads and polymer beads.

According to an exemplary embodiment, the diffusion adhesive layer includes a haze of approximately 80% to approximately 90%.

According to an exemplary embodiment, the diffusion adhesive layer includes a thickness of approximately 15 μm to approximately 25 μm.

According to an exemplary embodiment, the polarizer further includes an anti-reflection layer formed on the diffusion adhesive layer which blocks a diffused reflection of externally incident light.

According to an exemplary embodiment, the anti-reflection layer is formed of a transparent high molecular material including at least one of polyethylene terephthalate (“PET”) and copolymer.

According to an exemplary embodiment, the anti-reflection layer includes a thickness of approximately 25 μm to approximately 100 μm.

In another exemplary embodiment, the present invention provides a display device including a display panel which displays images; a backlight unit formed under the display panel which supplies light to the display panel, a first polarizer formed between the display panel and the backlight unit which polarizes light, and a second polarizer formed on the display panel which polarizes light, wherein the second polarizer includes a diffusion adhesive layer which diffuses light incident from the backlight unit and prevents a diffused reflection of externally incident light.

According to an exemplary embodiment, the display device further includes an anti-reflection layer formed on the diffusion adhesive layer.

The backlight unit includes a light source which generates light, and a first light guide member formed near a side of the light source and supplying the light generated from the light source to the display panel, the first light guide member having a negative prism pattern on a rear side thereof.

According to an exemplary embodiment, the light source includes at least one light emitting diode (“LED”) arranged near a side of the first light guide member.

According to an exemplary embodiment, the light source further includes a second light guide member facing a side of the first light guide member, and at least one light emitting diode arranged near a side of the second light guide member.

According to an exemplary embodiment, the display panel includes a first substrate on which a thin film transistor array is formed, a second substrate facing the first substrate, and a liquid crystal layer disposed between the first and second substrates, the liquid crystal layer including a twisted nematic (“TN”) liquid crystal layer.

According to an exemplary embodiment, the display device further includes a first alignment layer formed on the first substrate, and a second alignment layer formed on the second substrate, wherein the first alignment layer and the second alignment layer are perpendicular to each other in an alignment orientation.

According to an exemplary embodiment, the first alignment layer and the second alignment include an alignment horizontal or vertical to a side of the display panel.

### BRIEF DESCRIPTION OF THE DRAWINGS

The above and other aspects, features and advantages of the present invention will become apparent from the following detailed description when taken in conjunction with the accompanying drawings, in which:

FIG. 1 is an exploded perspective view illustrating an exemplary embodiment of an LCD device according to the present invention;

FIG. 2 is a cross sectional view taken along the line I-I′ of FIG. 1;

FIG. 3 is a perspective view illustrating an exemplary embodiment of a backlight unit shown in FIG. 1;

FIG. 4 is a cross sectional view illustrating an exemplary embodiment of a first polarizer shown in FIGS. 1 and 2;

FIG. 5 is a cross sectional view illustrating an exemplary embodiment of a second polarizer shown in FIGS. 1 and 2;

FIG. 6 is a perspective view illustrating another exemplary embodiment of a backlight unit of an LCD device according to the present invention;

FIG. 7A is a chromaticity diagram illustrating a color shift regarding green in a conventional TN mode LCD device;

FIG. 7B is a chromaticity diagram illustrating an exemplary embodiment of a color shift regarding green in an LCD device according to the present invention;

FIG. 8A is a chromaticity diagram illustrating a color shift regarding orange in a conventional TN mode LCD device;

FIG. 8B is a chromaticity diagram illustrating an exemplary embodiment of a color shift regarding orange in an LCD device according to the present invention;

FIG. 9A is a chromaticity diagram illustrating a color shift regarding black in a conventional TN mode LCD device;

FIG. 9B is a chromaticity diagram illustrating an exemplary embodiment of a color shift regarding black in an LCD device according to the present invention;

FIG. 10A is a graph illustrating a relationship of brightness and gray scale depending on the view angle of a conventional TN mode LCD device;

FIG. 10B is a graph illustrating an exemplary embodiment of a relationship of brightness and gray scale depending on the view angle of an LCD device according to the present invention;

FIG. 11A is a plan view illustrating a conventional polarizer included in an LCD device; and

FIG. 11B is a plan view illustrating an exemplary embodiment of a polarizer included in an LCD device according to the present invention.

### DETAILED DESCRIPTION OF THE INVENTION

The invention is described more fully hereinafter with reference to the accompanying drawings, in which exemplary embodiments of the invention are shown. The present invention may, however, be embodied in many different forms and should not be construed as being limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another elements as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower”, can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Hereinafter, exemplary embodiments of the present invention will be described in detail with reference to the accompanying drawings.

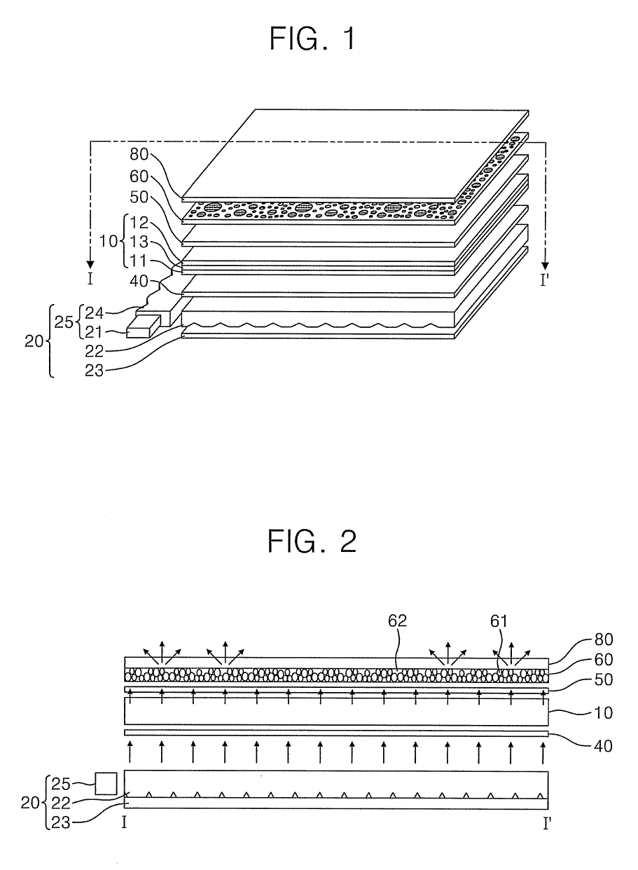

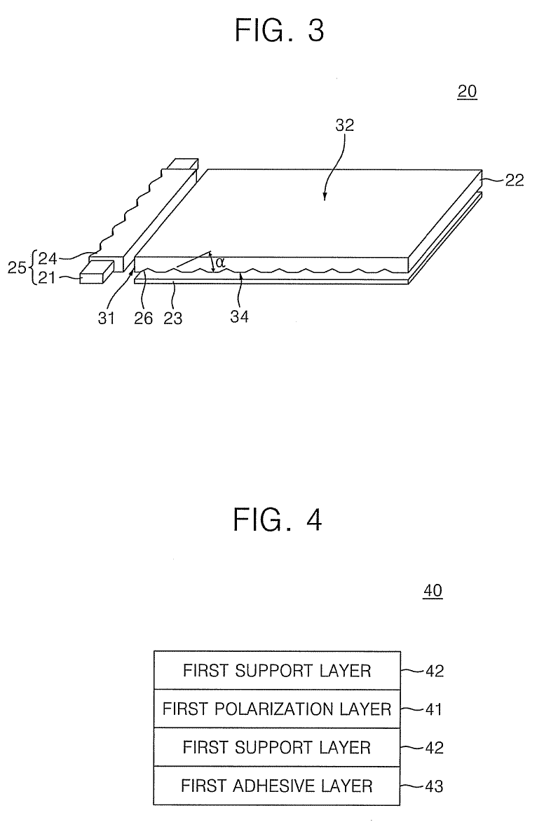

FIG. 1 is an exploded perspective view of an exemplary embodiment of an LCD device according to the present invention. FIG. 2 is a cross sectional view taken along the line I-I′ of FIG. 1. FIG. 3 is a perspective view illustrating an exemplary embodiment of a backlight unit shown in FIG. 1.

Referring to FIGS. 1 through 3, the LCD device includes an LCD panel 10, a backlight unit 20, a first polarizer 40, and a second polarizer 50. The second polarizer 50 includes a diffusion layer 60.

Further, the LCD panel 10 includes a color filter substrate 12 having a color filter, a thin film transistor (“TFT”) substrate 11 which includes a TFT, and a liquid crystal layer 13 disposed between the color filter substrate 12 and the TFT substrate 11.

A sub pixel is arranged on the LCD panel 10 in a matrix form, which is independently driven by a TFT. While the liquid crystal molecules are aligned based on a differential voltage of a common voltage supplied to a common electrode and a pixel voltage supplied to a pixel electrode, the light transmittance is adjusted to display images.

According to an exemplary embodiment, the liquid crystal molecules are aligned in a TN mode. Thus, the TFT substrate and the color filter substrate, respectively, may further include an alignment layer (not shown). The alignment layers are arranged to be perpendicular to each other. The alignment direction of the alignment layer may be in parallel with or vertical to the LCD panel.

According to an exemplary embodiment, the backlight unit 20 includes a light source 25, a reflective sheet 23, and a first light guide member 22.

The light source 25 is arranged near a side of the first light guide member 22 to generate light. The light source 25 includes at least one a light emitting diode (LED) 21 or lamp. According to an alternative exemplary embodiment, the light source 25 includes a plurality of LEDs 21.

According to an exemplary embodiment, as shown in FIG. 3, the LEDs 21 are arranged near an incident surface 31 of the first light guide member 22 in order to supply light to the first light guide member 22.

According to an exemplary embodiment, the light source 25 further includes a second light guide member 24 to reduce the number of the LEDs and prevent deteriorations such as the occurrence of bright line.

According to an exemplary embodiment, the second light guide member 24 is located near a side of the first light guide member 22. According to another exemplary embodiment, the LEDs 21 are located near both sides of the second light guide member 24. The light generated from the LED 21 is directed to the incident surface 31 of the first light guide member 22 via the second light guide member 24. As shown in FIG. 2, the first light guide member 22 includes a top surface 32 located under the LCD panel 10, a bottom surface 34 facing the top surface 32, and an incident surface 31 facing the light source 25. The first light guide member 22 includes a negative prism pattern 26 on a rear surface thereof.

According to an exemplary embodiment, the negative prism pattern 26 includes a plurality of negative prism lines arranged in parallel with the incident surface 31. Each negative prism line includes a constant height and pitch. According to an exemplary embodiment, the negative prism line increases in size in a direction leading away from the incident surface 31.

An angle between a side surface and the bottom surface 34 of the negative prism line, i.e. prism light emitting angle (α), is in the range of approximately 40 degrees to approximately 50 degrees. According to one exemplary embodiment, the prism light emitting angle (α) is approximately 45 degrees. According to an exemplary embodiment, the negative prism pattern 26 is direct incident light to the LCD panel 10.

The reflective sheet 23, located between the light source 25 and a bottom chassis, reflects the light directed to the reflective sheet 23 back toward the first light guide member 22.

The first polarizer 40 is located between the LCD panel 10 and the backlight unit 20, and the second polarizer 50 is located on the LCD panel 10. The first polarizer 40 and the second polarizer 50 are perpendicular to each other with respect to their polarization axes. The alignment direction of the alignment layer (not shown) formed on the LCD panel 10 may be oriented in the same direction as that of the polarization axis.

FIG. 4 is a cross sectional view illustrating an exemplary embodiment of a first polarizer shown in FIGS. 1 and 2.

Referring to FIG. 4, the first polarizer 40 includes a first adhesive layer 43, a first polarization layer 41, and a first support layer 42.

The first polarization layer 41 is formed by soaking a heated, extended thin PVA (poly vinyl alcohol) film into iodic acid or dichromatic dye solution. The first polarization layer 41 includes a polarization axis perpendicular to its extension axis, in the direction of which the first polarization layer 41 has been extended. The first polarization layer 41 divides incident light into two polarized components, one absorbed or diffused, the other transmitted. The first polarization layer 41 includes a thickness of approximately a few hundred micrometers.

The first polarization layer 41 includes dual characteristics, one such as polyvinylalcohol, which has strong hydrophilic properties, the other such as iodine, which has sublimation properties. The first support layer 42 prevents the change or deterioration in polarizing capacity of the first polarization layer 41 as exposed in air. The first support layer 42 is formed of transparent tri-acetylcellulose (“TAC”) whose phase difference is near zero not to affect the polarizing state of the transmitted light. According to an exemplary embodiment, the first support layer 42 may be arranged on one side or both sides of the first polarization layer 41. The first polarization layer 42 includes a thickness of approximately a few hundred micrometers.

The first adhesive layer 43 includes an adherent material. The first adhesive layer 43 attaches the first polarization layer 40 on the bottom surface of the LCD panel 10.

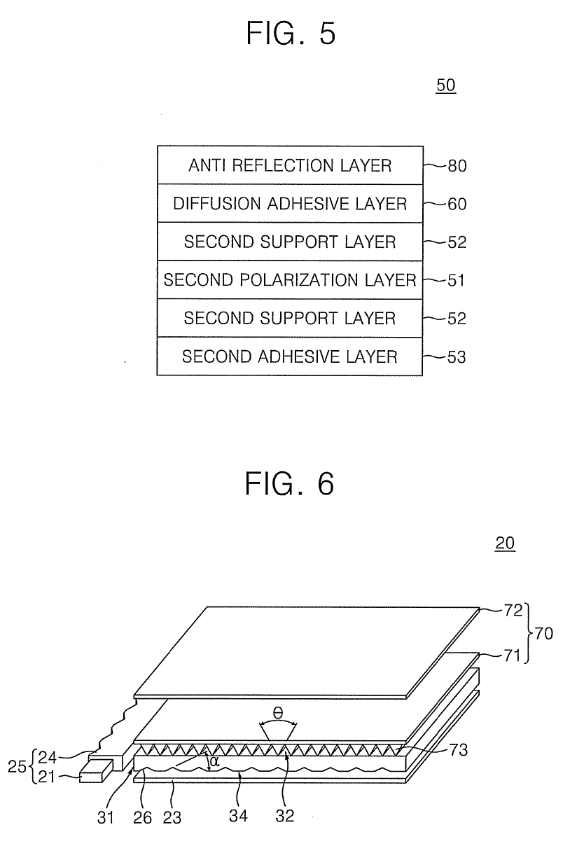

FIG. 5 is a cross sectional view illustrating the second polarizer shown in FIGS. 1 and 2.

Referring to FIG. 5, the second polarizer 50 includes a second adhesive layer 53, a second support 52, a second polarization layer 51, a diffusion adhesive layer 60, and an anti-reflection layer 80.

According to an exemplary embodiment, the second adhesive layer 53 and the support layer 52 have the same configurations and effects as those of the first adhesive layer 43 and the first support layer 42, and thus, the detailed descriptions will not be repeated.

The second polarization layer 51 is formed by soaking a heated, extended thin PVA (poly vinyl alcohol) film into iodic acid or dichromatic dye solution. The second polarization layer 51 includes a polarization axis perpendicular to its extension axis, in the direction of which the second polarization layer 51 has been extended. The second polarization layer 51 includes a polarization axis perpendicular to the polarization axis of the first polarization layer 41.

According to an exemplary embodiment, the diffusion adhesive layer 60 is formed on the second polarizer 50. The diffusion adhesive layer 60 includes a number of diffusion particles that function as a light diffuser. For example, the diffusion adhesive layer 60 includes transparent diffusion particles such as at least one of silica beads and polymer beads. The diffusion adhesive layer 60 includes a haze of approximately 80% to approximately 90%, taking into consideration the diffusion efficiency and transmittance of the LCD device. And, the diffusion adhesive layer 60 includes a thickness of approximately 15 μm to approximately 25 μm. As the diffusion adhesive layer 60 becomes thinner, the diffusion efficiency may be excessively reduced owing to the difficulty in accommodating the diffusion particles, on the contrary, as becoming thicker, the transmittance greatly decreases.

The light incident from the outside to the diffusion adhesive layer 60 is transmitted to the LCD panel 10 without any reflection. The light incident from the backlight unit to the diffusion adhesive layer 60 is transmitted to the outside without any reflection. The light originated from the backlight unit and passed through the LCD panel 10 is diffused or scattered on the diffusion adhesive layer 60.

Originally, the light that has passed through the LCD panel 10 will cause color shifts and gray scale inversions due to the double refraction. However, the color shifts and gray scale inversion are not seen in the exemplary embodiments of the present invention since the diffusion adhesive layer 60 diffuses light. This allows for an improved view angle of the LCD device.

Moreover, the visibility of the LCD device may be enhanced. In particular, although the amount of external light increases, most of them go through the diffusion adhesive layer 60 without any reflection, and therefore, there is little influence on visibility.

According to an exemplary embodiment, an anti-reflection layer 80 is provided on the diffusion adhesive layer 60. The anti-reflection layer 80 protects the diffusion adhesive layer 60 and blocks and prevents the reflection of the externally incident light. The anti-reflection layer 80 includes a transparent high molecular material, such as at least one of polyethylene terephthalate (“PET”) and copolymer. For improved reflectivity, a hard coating treatment or anti reflect coating treatment may be performed on the anti-reflection layer 80, or a film may be attached on the anti-reflection layer 80, such as an anti-glare film, non-reflect film, and low reflect film. According to an exemplary embodiment, the anti-reflection layer 80 includes a thickness of approximately 25 μm to approximately 100 μm, taking anti-reflection efficiency and transmittance into consideration. The diffusion adhesive layer 60 is formed evenly on its outer surface, and the diffusion particles 61 contained in the diffusion adhesive layer 60 causes forward scattering, so that the diffused reflection of the external light may be reduced. Accordingly, the visibility may also be improved.

According to an exemplary embodiment, the second polarizer 50, the second support layer 52, the second polarization layer 51, and the diffusion adhesive layer 60 are integrally formed.

According to an exemplary embodiment, the LCD device further includes the backlight unit 20 as shown in FIG. 6. The backlight unit 20 further includes an optical sheet 70 as compared with the backlight unit 20 shown in FIGS. 1 and 2.

According to an exemplary embodiment, the optical sheet 70 includes a prism sheet 71 and a protective sheet 72.

The prism sheet 71 collects the light supplied from the first light guide member 22 toward the LCD panel 10. The prism sheet 71 includes a plurality of micro prisms 73, each shaped as a triangle, arranged on its surface in a constant orientation. According to an exemplary embodiment, the micro prisms 73 protrude in the direction of the first light guide member 22. The micro prism 73 includes a prescribed angle (θ) of approximately 65 degrees to approximately 75 degrees. The prism sheet 71 is formed by overlapping two or more pieces. The light that has passed through the prism sheet 71, mostly, is directed perpendicularly to provide a uniform distribution in brightness.

The protective sheet 72 protects the prism sheet 71 due to a weakness in scratching.

According to an exemplary embodiment, the optical sheet 70 further includes a diffusion sheet. The diffusion sheet is disposed between the prism sheet and the light guide member. The diffusion sheet diffuses the light supplied from the first light guide member 22, so that the light can be evenly illuminated toward the LCD panel 10.

The prism light emitting angle (α) may become small when the prism sheet 71 is disposed on the first light guide member 22. In this case, the prism light emitting angle (α) may be in the range of approximately 2 degrees to approximately 5 degrees.

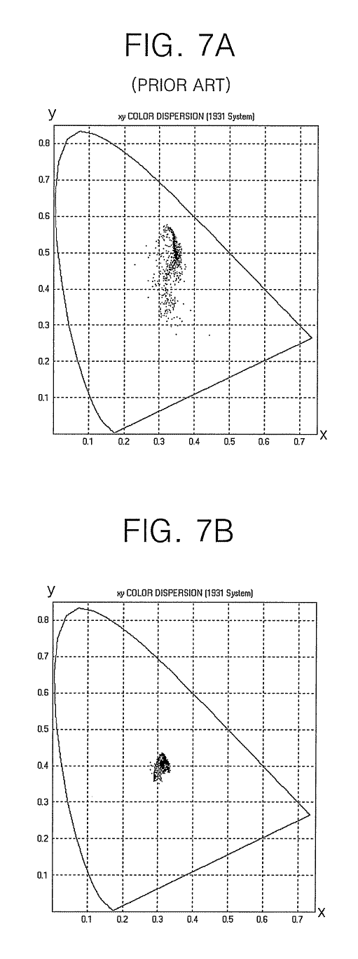

FIG. 7A is a chromaticity diagram illustrating a color shift regarding green in a conventional TN mode LCD device, and FIG. 7B is a chromaticity diagram illustrating a color shift regarding green in an LCD device according to an exemplary embodiment of the present invention.

Referring to FIG. 7A, the conventional TN mode LCD device shows Δx of 0.10 and Δy of 0.22, where Δx refers to a changing rate of color dispersion in X axis, Δy in Y axis.

On the contrary, the LCD device according to the exemplary embodiment of the present invention, shows Δx of 0.05 and Δy of 0.08 as shown in FIG. 7B. This indicates the LCD device of the present invention shows concentrated color dispersion around a green spectrum.

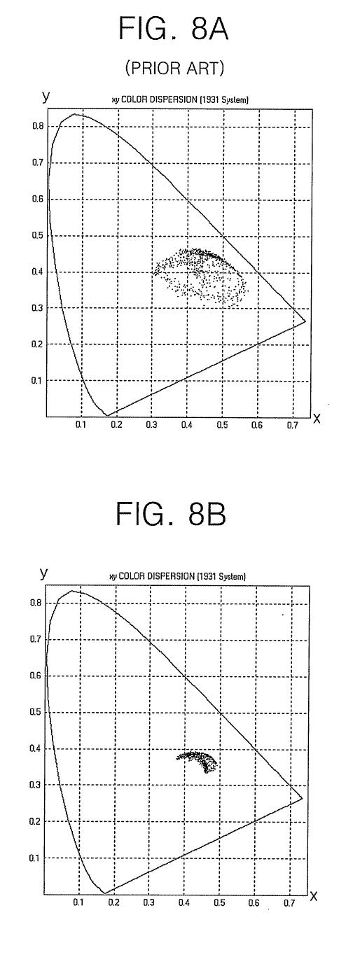

FIG. 8A is a chromaticity diagram illustrating a color shift regarding orange in a conventional TN mode LCD device, and FIG. 8B is a chromaticity diagram illustrating a color shift regarding orange in an LCD device according to an exemplary embodiment of the present invention.

Referring to FIG. 8A, the conventional TN mode LCD device shows Δx of 0.25 and Δy of 0.15 with respect of an orange spectrum of light. On the contrary, the LCD device of the present invention shows Δx of 0.11 and Δy of 0.05.

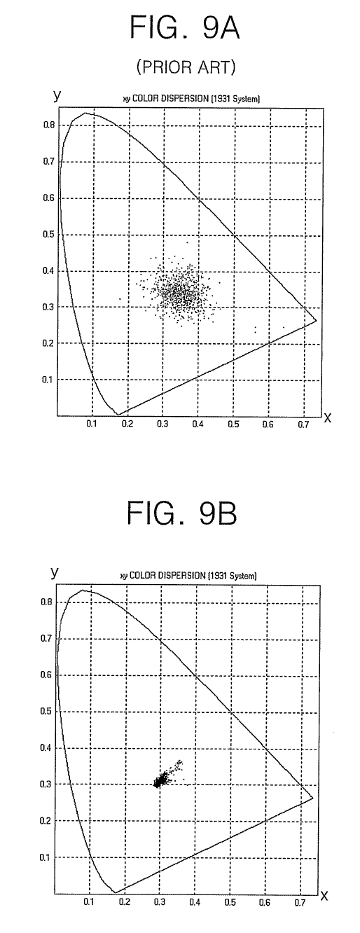

FIG. 9A is a chromaticity diagram illustrating a color shift regarding black in a conventional TN mode LCD device, and FIG. 9B is a chromaticity diagram illustrating a color shift regarding black in an LCD device according to an exemplary embodiment of the present invention.

Referring to FIG. 9A, the conventional TN mode LCD device shows Δx of 0.20 and Δy of 0.19 with respect of a black spectrum of light. On the contrary, the LCD device of the present invention shows Δx of 0.07 and Δy of 0.08.

As can be seen in FIGS. 7A to 9B, the color shift was reduced by the factor of 50% or less, and the view angles were improved in the upper, lower, left, and right directions in the LCD device of the present invention.

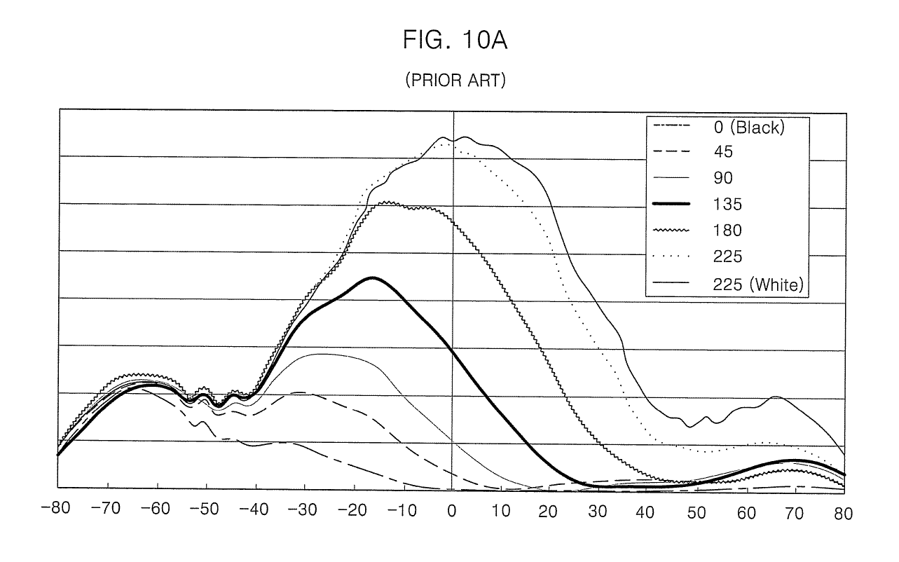

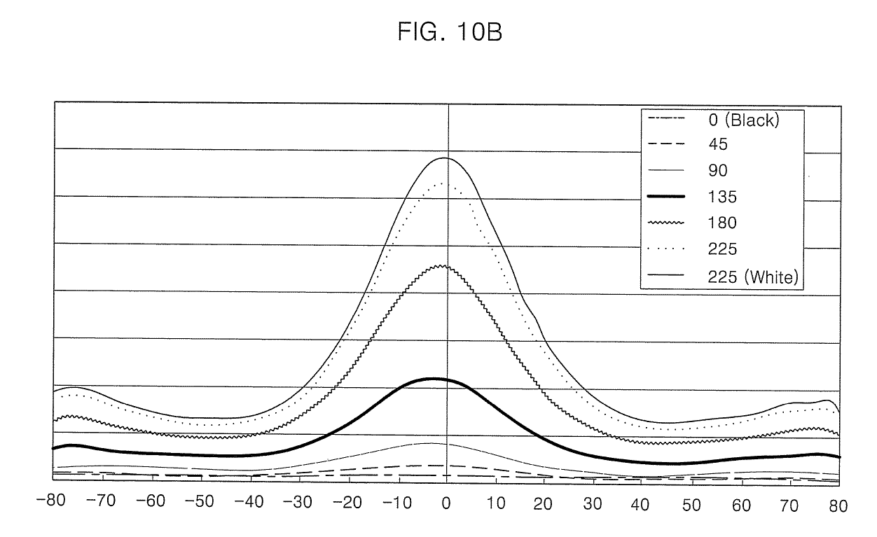

FIG. 10A is a graph illustrating a relationship of brightness and gray scale depending on the view angle of a conventional TN mode LCD device, and FIG. 10B is a graph illustrating a relationship of brightness and gray scale depending on the view angle of an LCD device according to an exemplary embodiment of the present invention. In FIGS. 10A and 10B, the horizontal axis refers to view angles, and the vertical axis refers to the brightness. The gray scale includes 45, 90, 135, 180, 225, and 255.

Referring to FIG. 10A, gray scales 225, 180, and 135 are inverted around the right view angles of approximately 18 degrees to approximately 31 degrees. A brightness inversion can also be seen around the left view angles of approximately 10 degrees to approximately 45 degrees. It can also be seen the brightness is asymmetrical in the left and right view angles.

In contrast, the LCD device of the present invention includes the symmetrical brightness distribution in the left and right view angles as shown in FIG. 10B. In addition, any brightness inversion does not occur all over the left and right view angles.

Accordingly, as seen from a side, the LCD device may show reduced brightness, but not any brightness inversion.

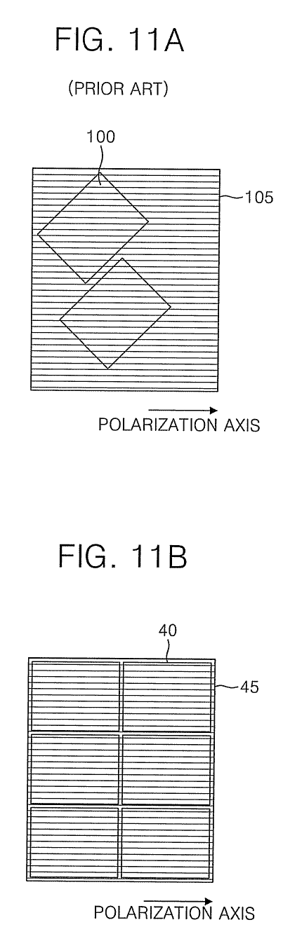

FIG. 11A is a plan view illustrating a polarizer included in a conventional LCD device.

Referring to FIG. 11A, the conventional TN mode LCD device has the rubbing direction of the alignment layer oriented diagonally, for example, in the angled direction of about 30 degrees to about 60 degrees. However such a construction may cause a loss near an end 105 of the polarizer 100 upon manufacturing, since one of the first polarizer and second polarizer needs to be designed so that its polarization axis is in parallel with the rubbing direction.

FIG. 11B is a plan view illustrating a polarizer included in an LCD device according to an exemplary embodiment of the present invention.

The LCD device of the present invention may rub the alignment layer in the horizontal or vertical rubbing direction. The horizontal or vertical rubbing direction based on the LCD panel 10 may prevent any damage to the end 45 of the polarizer 40 since the polarizer 40 may be cut horizontally or vertically with respect to the polarization axis.

As described above, the exemplary LCD device of the present invention may improve the view angle and visibility by forming a diffusion adhesive layer 60 on a polarizer 50 to cause a forward diffusion.

The exemplary LCD device of the present invention may improve the brightness by providing a prism pattern on the backlight unit 20 to enhance the light collection efficiency

The exemplary LCD device of the present invention may improve the visibility by forming the anti-reflection layer 80 on the diffusion adhesive layer 60.While the present invention has been shown and described with reference to some exemplary embodiments thereof, it should be understood by those of ordinary skill in the art that various changes in form and detail may be made therein without departing from the spirit and scope of the present invention as defined by the appending claims.

What is claimed is:

1. A polarizer comprising:
a polarization layer which polarizes light;
a support layer formed on at least one side of the polarization layer; and
a diffusion adhesive layer formed on the polarization layer, which diffuses light incident from the polarization layer and prevents a diffused reflection of light incident from an opposite direction of the polarization layer.

2. The polarizer of claim 1, wherein the diffusion adhesive layer comprises transparent diffusion particles including at least one of silica beads and polymer beads.

3. The polarizer of claim 2, wherein the diffusion adhesive layer comprises a haze of approximately 80% to approximately 90%.

4. The polarizer of claim 3, wherein the diffusion adhesive layer comprises a thickness of approximately 15 μm to approximately 25 μm.

5. The polarizer of claim 1, further comprising:
an anti-reflection layer formed on the diffusion adhesive layer which blocks and prevents a diffused reflection of externally incident light.

6. The polarizer of claim 5, wherein the anti-reflection layer comprises a transparent high molecular material including at least one of polyethylene terephthalate and copolymer.

7. The polarizer of claim 6, wherein the anti-reflection layer comprises a thickness of approximately 25 μm to approximately 100 μm.

8. A display device comprising:
a display panel to display an image;
a backlight unit formed under the display panel which supplies light to the display panel;
a first polarizer formed between the display panel and the backlight unit which polarizes light; and
a second polarizer formed on the display panel which polarizes light and comprising:
a diffusion adhesive layer which diffuses light incident from the backlight unit and blocks and prevents a diffused reflection of externally incident light.

9. The display device of claim 8, wherein the diffusion adhesive layer comprises transparent diffusion particles comprises at least one of silica beads and polymer beads.

10. The display device of claim 9, wherein the diffusion adhesive layer comprises a haze of approximately 80% to approximately 90%.

11. The display device of claim 10, wherein the diffusion adhesive layer comprises a thickness of approximately 15 μm to approximately 25 μm.

12. The display device of claim 8, further comprising:
an anti-reflection layer formed on the diffusion adhesive layer and blocking and preventing a diffused reflection of externally incident light.

13. The display device of claim 12, wherein the anti-reflection layer comprises a transparent high molecular material that comprises at least one of polyethylene terephthalate and copolymer.

14. The display device of claim 13, wherein the anti-reflection layer comprises a thickness of approximately 25 μm to approximately 100 μm.

15. The display device of claim 8, wherein the backlight unit comprises:
a light source which generates light; and
a first light guide member formed at a side of the light source which supplies the light generated from the light source to the display panel, the first light guide member having a negative prism pattern on a rear side thereof.

16. The display device of claim 15, wherein the light source comprises at least one light emitting diode arranged at a side of the first light guide member.

17. The display device of claim 16, wherein the light source further comprises a second light guide member facing a side of the first light guide member, and at least one light emitting diode arranged at a side of the second light guide member.

18. The display device of claim 8, wherein the display panel comprises:
a first substrate on which a thin film transistor array is formed;
a second substrate facing the first substrate; and
a liquid crystal layer disposed between the first and second substrates, the liquid crystal layer comprising a twisted nematic liquid crystal layer.

19. The display device of claim 18, further comprising:
a first alignment layer formed on the first substrate, and
a second alignment layer formed on the second substrate, wherein the first alignment layer and the second alignment layer are perpendicular to each other in an alignment orientation.

20. The display device of claim 19, wherein the first alignment layer and the second alignment comprise an alignment horizontal or vertical to a side of the display panel.
